(19) United States
(12) Patent Application Publication
(10) Pub. No.: US 2026/0212719 A1
(43) Pub. Date: Jul. 23, 2026

(54) DISTRIBUTED ALGORITHM FOR AUTOMIXING SPEECH OVER WIRELESS NETWORKS

(71) Applicant: Shure Acquisition Holdings, Inc., Niles, IL (US)

(72) Inventors: Steven Christopher Moles, Lincolnshire, IL (US); Stephen David Moore, Livingston (GB); Michael Ryan Lester, Colorado Springs, CO (US)

(21) Appl. No.: 19/416,533

(22) Filed: Dec. 11, 2025

Related U.S. Application Data
(63) Continuation of application No. 18/051,658, filed on Nov. 1, 2022, now Pat. No. 12,525,083.
(60) Provisional application No. 63/263,641, filed on Nov. 5, 2021.

(51) Int. Cl. G07C 9/25; G10L 17/00; H04R 1/40; H04R 3/00

(52) U.S. Cl. CPC G07C 9/25; G10L 17/00; H04R 1/406; H04R 3/005; H04R 2420/07

(57) ABSTRACT

Systems and methods are disclosed for operating a wireless audio network including a plurality of wireless microphone units (e.g., wireless delegate units) and a central access point having a mixer. The wireless microphone units may perform voice detection and level sensing, and make a preliminary gating decision. The central access point may make a final gating decision, determine the granting of wireless communications channels, and generate a final mixed audio output signal.

### CROSS-REFERENCE

This application is a continuation of U.S. Patent Application No. 18/051,658, filed on November 1, 2022, which claims the benefit of U.S. Provisional Patent Application No. 63/263,641, filed on November 5, 2021, both of which are incorporated herein by reference in their entireties.

### TECHNICAL FIELD

This application generally relates to systems and methods for networked audio automixing in wireless networks. In particular, this application relates to systems and methods for distributed processing and gating decision making between one or more wireless microphone units and a central access point or mixer, to enable optimized granting of wireless audio channels to particular wireless microphone unit(s).

### BACKGROUND

Conferencing and presentation environments, such as boardrooms, conferencing settings, and the like, can involve the use of multiple wireless microphones for capturing sound from various audio sources. The audio sources may include human speakers, for example. The captured sound may be disseminated to a local audience in the environment through amplified speakers (for sound reinforcement), and/or to others remote from the environment (such as via a telecast and/or a webcast). The audio from each microphone may be wirelessly transmitted to a central access point for processing, such as for determining the granting of wireless communication channels and/or for mixing of the audio from the microphones.

Typically, captured sound may also include noise (e.g., undesired non-voice or non-human sounds) in the environment, including constant noises such as from ventilation, machinery, and electronic devices, and errant noises such as sudden, impulsive, or recurrent sounds like shuffling of paper, opening of bags and containers, chewing, typing, etc. To minimize noise in captured sounds, the central access point may include an automixer that can be utilized to automatically gate and/or attenuate a particular microphone’s audio signal to mitigate the contribution of background, static, or stationary noise when it is not capturing human speech or voice. Voice activity detection (VAD) algorithms may also be used to minimize errant noises in captured sound by detecting the presence or absence of human speech or voice. Other noise reduction techniques can reduce certain background, static, or stationary noise, such as fan and HVAC system noise.

In the context of a wireless audio system, the inclusion of multiple microphones that are communicatively coupled to the automixer may bring additional challenges related to latency, channel allocation for the various microphones, gating decisions, noise mitigation, and more.

Accordingly, there is an opportunity for systems and methods that address these concerns. More particularly, there is an opportunity for systems and methods for a network of wirelessly connected devices that can each perform portions of the gating decision process in order to offload processing from the central access point. Further, there is an opportunity for systems and methods that enable a determination by a central access point of which microphones to grant wireless communications channels in order to reduce the amount of bandwidth required by the system at any given time. Still further, there is an opportunity for systems and methods that enable the wireless audio system to address issues with latency caused by the time delays required to perform various aspects of the decision making and channel setup.

### SUMMARY

The invention is intended to solve the above-noted problems by providing systems and methods that are designed to, among other things: (1) utilize a system having distributed processing, wherein the processing capability of individual wireless microphone units (e.g., wireless delegate units (WDUs)) are used to determine preliminary gating decisions for the wireless microphone unit (without the need for transmitting audio data to a central access point having a mixer); (2) transmitting an access request from the wireless microphone unit to the central access point when the wireless microphone unit determines that an input audio signal at the wireless microphone unit is above a given threshold and/or meets certain requirements; (3) determine, by the central access point, a winning wireless microphone unit when multiple access requests are received from multiple wireless microphone units within a given period of time, e.g., a “competition period;” and (4) grant the winning wireless microphone unit a wireless communication channel to enable the transmission of audio data from the winning wireless microphone unit to the central access point (which can then be processed by the mixer in the central access point to produce an output mixed audio signal).

In an embodiment, a wireless audio system may include a plurality of wireless microphone units and a central access point having a mixer. Each of the plurality of wireless microphone units may include one or more microphones or microphone arrays, each configured to provide one or more audio input signals, and a processing unit. The processing unit may be configured to receive one or more input audio signals from the microphones or microphone arrays, and determine whether the input audio signal(s) are above one or more thresholds or meet certain criteria. Upon determining that a given input audio signal is above the threshold(s) or meets the criteria, the wireless microphone unit may then transmit an access request to the central access point to request that a wireless communication channel be granted for that wireless microphone unit. The central access point may receive the access request, and begin a competition period during which other wireless microphone units may transmit access requests to the central access point. The central access point then determines a winner or best wireless microphone unit based on all the received access requests received during the competition period, and grants the winning wireless microphone unit a wireless communication channel. The central access point may also be configured to generate a final mix audio signal based the audio signal from all the gated on wireless microphone units, and/or all the wireless microphone units for which there is an active communication channel with the central access point.

This and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a schematic diagram of a system including a plurality of wireless microphone units (such as wireless delegate units (WDUs)), and a central access point for automixing of audio signals and for granting of wireless communications channels, in accordance with some embodiments.

FIG. 2 is a flowchart illustrating operations performed by the wireless microphone units when an audio signal is detected, in accordance with some embodiments.

FIG. 3 is a flowchart illustrating operations performed by the central access point, in accordance with some embodiments.

FIG. 4 is a timing diagram illustrating the timing of certain events performed by the wireless microphone unit and the central access point, in accordance with some embodiments.

### DETAILED DESCRIPTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

The systems and methods described herein can include an audio system that includes a plurality of wireless microphone units, such as wireless delegate units (WDUs), and a central access point having a mixer. The system may include any number of wireless microphone units, such as 1, 10, 100, or more, all positioned within an environment or multiple environments. The central access point of the system may be coupled to the plurality of wireless microphone units via one or more wireless communication channels, and may be configured to receive audio data (and/or other data) from the wireless microphone units in order to produce a final output mix signal.

In one exemplary scenario in which the system of this disclosure may be used, there may be a desire to prevent wireless microphone units from being gated on or transmitting audio to the central access point unless the audio picked up by the wireless microphone unit meets certain criteria. Additionally, where multiple wireless microphone units are positioned in relative close proximity (e.g., in a conference room), it is possible that a single audio source (e.g., a human talker) may be picked up by multiple wireless microphone units. It may be desirable for a decision to be made for which single designated or best wireless microphone unit is to be used for that single audio source, rather than having multiple wireless microphone unit all be gated on based on the single audio source. This decision making can enable fewer wireless communication channels to be utilized by the system.

In some examples, the wireless microphone units may transmit access requests to the central access point that request the granting of a wireless channel to the wireless microphone unit for the purpose of transmitting the input audio signal. However, due to the inherent uncertainty of the wireless environment, the first wireless microphone unit to detect a given audio source may not necessarily correspond to the first access request received by the central access point. The systems and methods described herein can be utilized to identify the "best" access request and enable the central access point to make a relatively more optimal decision about which wireless microphone unit is to be gated on and granted a wireless communication channel.

In embodiments of the present disclosure, processing and decision making may be split between the central access point and the wireless microphone units, which can enable improved operation without significantly increasing the processing or communication costs. When a person speaks and the audio is picked up by one or more wireless microphone units, each wireless microphone unit can make a determination on its own whether the input audio includes speech or other desirable audio, or whether the input audio is noise or other undesirable audio. This may be referred to as “voice detection,” and by enabling each wireless microphone unit to perform this step individually, the overall system processing can be distributed such that the central access point no longer makes these initial decisions.

The wireless microphone units may also make an initial or preliminary gating decision. The preliminary gating decision can involve comparing the input audio metrics (e.g., signal level) to various thresholds and criteria. If the wireless microphone unit determines that the input audio signal is not desirable, the wireless microphone unit does not transmit any access request to the central access point in association with this determination, thereby reducing the processing resources the central access point is otherwise tasked with. If the wireless microphone unit determines that the input audio signal is desirable, the wireless microphone unit can transmit an access request to the central access point. The central access point may then receive the access request from the wireless microphone unit (and possibly from one or more other wireless microphone units), and make a final gating decision to determine which of the wireless microphone units is to be granted a wireless communication channel. This may be particularly important where a single audio source (e.g., a person who begins speaking) is picked up by two or more wireless microphone units, all of which determine that the input audio is desirable. In this scenario, the central access point may receive access requests from each of the wireless microphone units that picked up the input audio and determined it was desirable, and then can determine which wireless microphone unit is relatively best suited to continue and provide the input audio to the central access point. The determined designated or otherwise best suited wireless microphone unit (“winner”) may then be granted a wireless communications channel, and audio transmission can occur between the winning wireless microphone unit and the central access point via this granted channel. The mixer in the wireless microphone unit may utilize the audio received via the granted channel to mix it with other gated on channels to generate the final mix output signal.

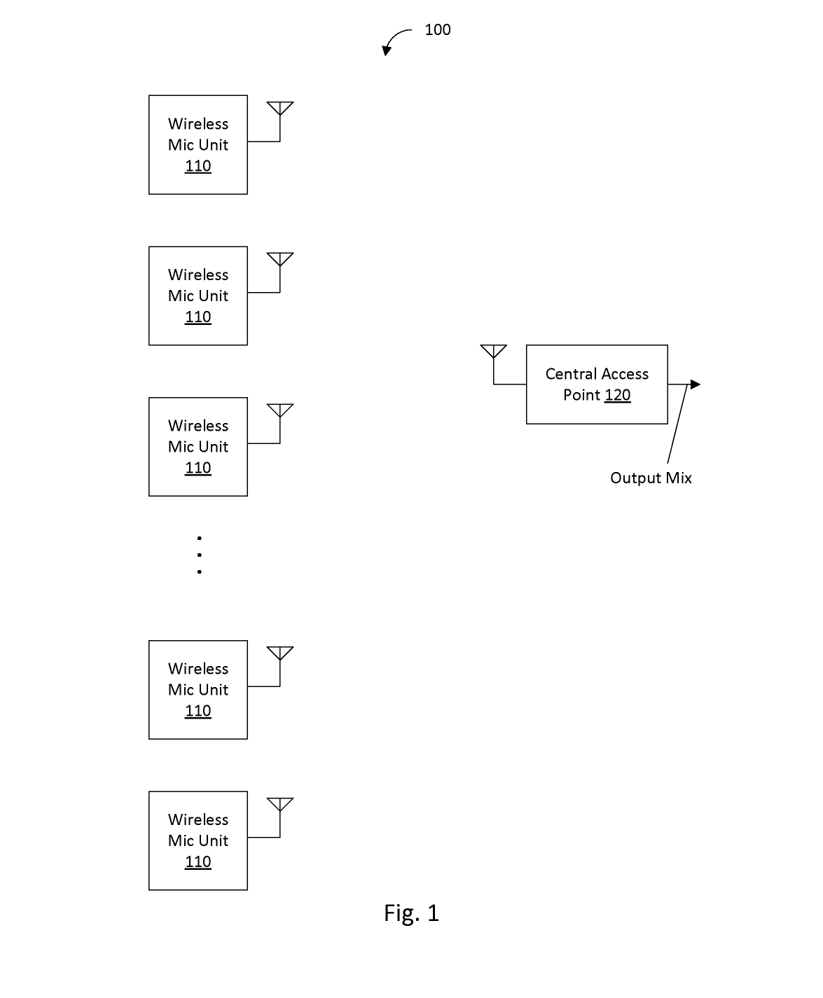

FIG. 1 is a schematic diagram of a system 100 including a plurality of wireless microphone units 110 (e.g., wireless delegate units) and a central access point 120 for the automixing of audio signals from one or more of the wireless microphone units 110 and for determining the granting of wireless communications channels. Environments such as conference rooms, churches, etc. may utilize the system 100 to facilitate communication with persons at a remote location and/or for sound reinforcement, for example. The environment may include desirable audio sources (e.g., human speakers) and/or undesirable audio sources (e.g., noise from ventilation, other persons, audio/visual equipment, electronic devices, etc.). The system 100 may result in the output of a final mix audio signal based on the granting of communication channels only to specific wireless microphone units that have been determined to be the best suited for capturing the desirable audio.

Each of the wireless microphone units 110 may detect sound in the environment, and be placed on or in a table, lectern, desktop, wall, ceiling, etc. so that the sound from the audio sources can be detected and captured, such as speech spoken by human speakers. Each of the wireless microphone units 110 may include any number of microphone elements, and in some cases may be able to form multiple pickup patterns with lobes so that the sound from the audio sources can be detected and captured. Any appropriate number of microphone elements are possible and contemplated in each of the wireless microphone units 110.

The various components included in the system 100 (e.g., the wireless microphone units 110 and the central access point 120) may be implemented using software executable by one or more computing devices, such as a laptop, desktop, tablet, smartphone, etc. Such a computer device may comprise one or more processors, memories, graphics processing units (GPUs), discrete logic circuits, application specific integrated circuits (ASIC), programmable gate arrays (PGA), field programmable gate arrays (FPGA), etc., one or more of which may be configured to perform some or all of the techniques described herein.

As described in more detail below, a processing unit in each of the wireless microphone units 110 may enable various functions, such as receiving the input audio signal, determining one or more levels or metrics associated with the input audio signal, determining whether the input audio signal includes speech or not (e.g., voice detection), making a preliminary gating decision, and causing the transmission of an access request.

The central access point 120 may receive an access request from one or more wireless microphone units 110, make a final gating decision for each wireless microphone unit that has sent a request within the competition period (as described in further detail below), and generate a final mix audio signal. In embodiments, the central access point 120 may also transmit updated winning metrics and other relevant information to one or more of the wireless microphone units, which may use the metrics in their preliminary gating decisions.

In some examples, the wireless microphone units 110 and the central access point 120, either alone or in combination, may be configured to eliminate or mitigate handling noise or “book drop” noise which may have been picked up by the wireless microphone units 110. For example, a voice activity detection (VAD) algorithm may perform spectral analysis of the input signal to classify the input signal as containing voiced speech, unvoiced speech, or non-speech. Non-speech classifications may be used during the preliminary gating decision to reduce unwanted channel requests. Additionally, non-speech classifications may be sent from the wireless microphone units 110 to the central access point 120, and those non-speech classifications which arrive shortly after the corresponding wireless microphone unit has been granted a channel may be used as a trigger or event that causes the central access point 120 to quickly release the channel (e.g., revoke the channel that was just granted to the wireless microphone unit), due to a likely false-trigger situation. In some embodiments, the wireless microphone units 110 may send a “release channel” control message to the central access point 120 to cause the central access point 120 to release the channel, if and when non-speech classifications are made within a short time window after a channel is granted.

In some examples, the wireless microphone units 110 and the central access point 120, either alone or in combination, may be configured to mitigate latency caused by the time delays resulting from the determination of the one or more metrics of the input audio signal, preliminary gating decision, transmission of an access request, and/or the final gating decision made by the central access point 120. When a channel has been granted and audio is being transmitted by a given microphone, the system may operate with a certain latency, e.g., approximately 15 ms. However, the time delay caused by the processes described herein (e.g., the preliminary gating decision, competition period, channel setup/grant, etc.) can increase the latency (e.g., to up to 100 ms or more).

To address such latencies, and to avoid cutting off the beginning portion of sound that is captured while the gating decisions and channel setup are being determined, the wireless microphone units 110 may be configured to execute a time compression algorithm that can: (1) store the input audio signal in a buffer, (2) compress the input audio in time by removing certain segments such as noise, silence, and certain periodic content, and (3) when a channel has been granted to the wireless microphone unit 110, begin playback of the time-compressed signal from the buffer until the latency is removed, and the audio is being transmitted in real time or near-real time. Exemplary embodiments of techniques for time-compression of an input audio signal are described in commonly-assigned U.S. Pat. No. 10,997,982, entitled “Systems and Methods for Intelligent Voice Activation for Auto-Mixing,” which is incorporated by reference in its entirety herein.

The system as a whole may benefit in each of these situations by limiting channel usage to only legitimate speech, while also preventing handling noises from contributing to the final output mix and/or from consuming valuable bandwidth.

The system 100 may include one or more features that enable the various functions of the wireless microphone units 110 and central access point 120 to operate. For instance, the system 100 may operate using a common clock signal. All devices that are a part of the system 100 may be time synchronized such that they are locked to a common clock signal. Furthermore, the system 100 may include a synchronized audio/wireless frame counter (e.g., where the system operates based on a frame scheme) for use as time stamps. Additionally, the system 100 may include sufficient radio frequency (RF) channel capacity for one or more uplink audio channels, such as channels for transmitting information from a wireless microphone unit 110 to the central access point 120.

Furthermore, the system 100 may include additional RF bandwidth for the purpose of carrying control signals, which may include channel requests (e.g., access requests) as well as other control information shared between the wireless microphone units 110 and the central access point 120. For instance, the system 100 may include one or more wireless “backchannels” or communication channels between one or more of the wireless microphone units 110 and the central access point 120. These wireless backchannels may enable communication of various data (e.g., control data, metrics or levels associated with the wireless microphone unit and any input audio signal, etc.) in both directions. That is, communication via the wireless backchannel can include transmitting data from the wireless microphone unit 110 to the central access point 120, and vice versa. These wireless backchannels may enable communication between a wireless microphone unit 110 and the central access point 120 both while the wireless microphone unit 110 is transmitting audio data and when it is not transmitting audio data. The wireless backchannel for a given wireless microphone unit 110 may be separate from a communication channel granted for the purpose of transmitting audio data.

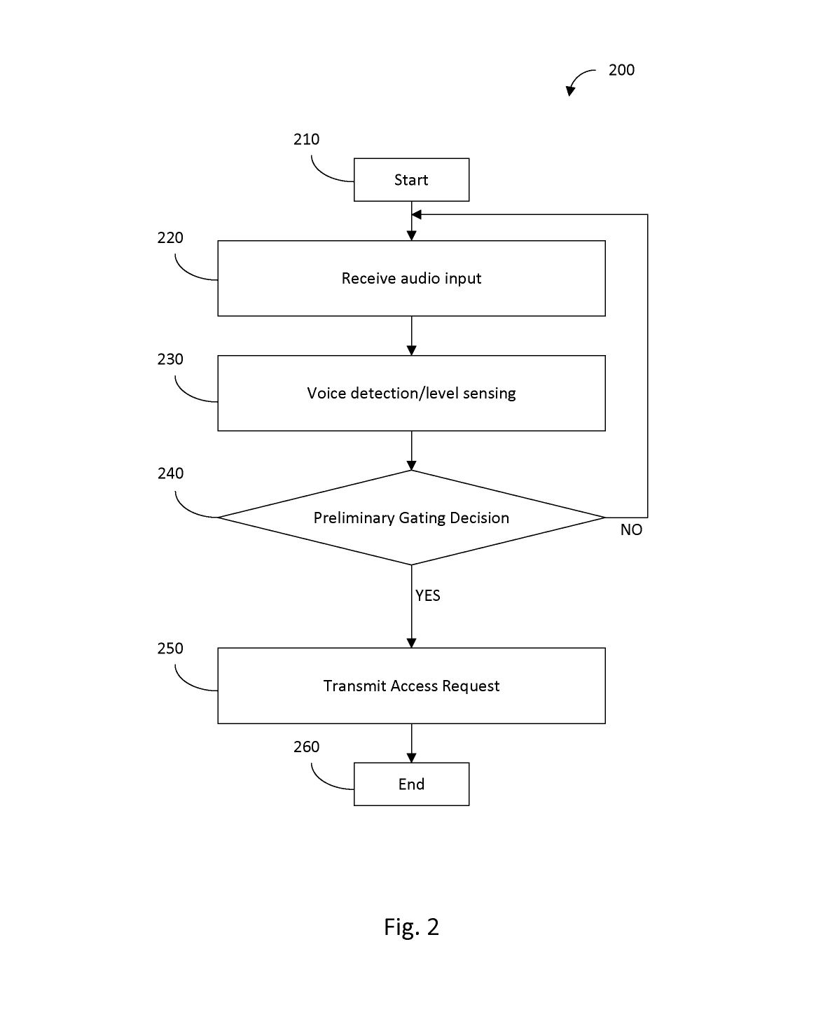

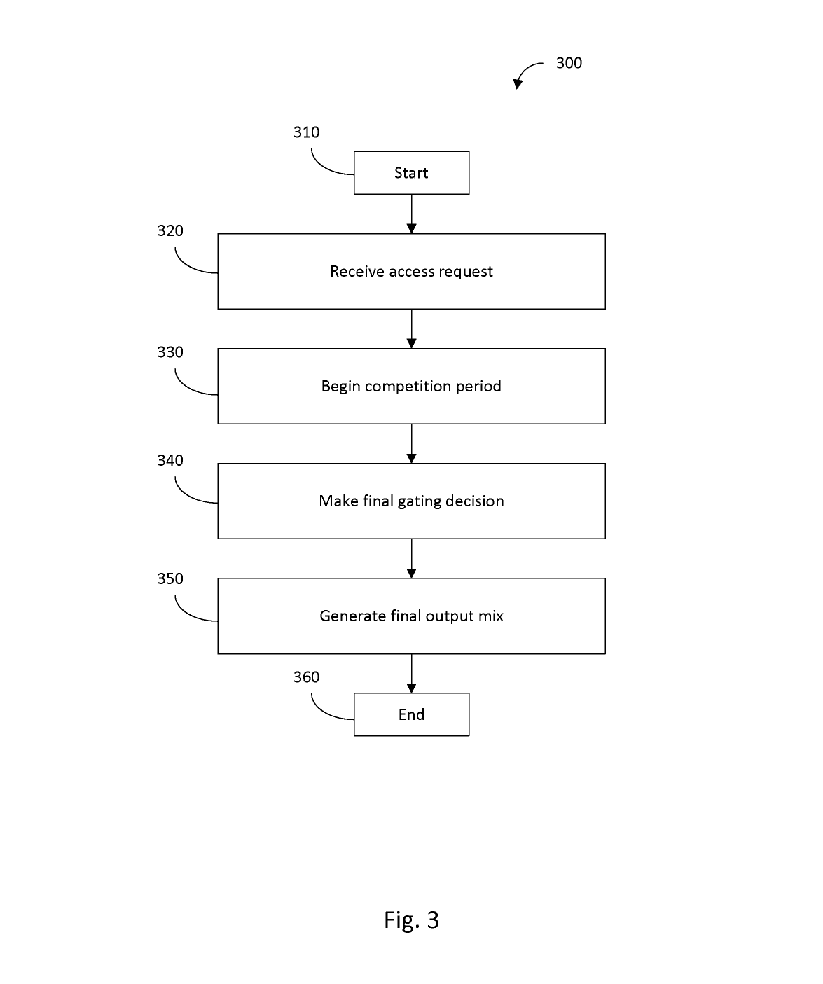

FIG. 2 includes a flow chart illustrating example functions that may be performed by the wireless microphone units 110, and FIG. 3 includes a flow chart illustrating example functions that may be performed by the central access point 120. One or more processors and/or other processing components (e.g., analog to digital converters, encryption chips, etc.) within the wireless microphone units 110 and/or central access point 120 may perform any, some, or all of the steps of the processes 200 and 300 of FIGS. 2 and 3. One or more other types of components (e.g., memory, input and/or output devices, transmitters, receivers, buffers, drivers, discrete components, etc.) may also be utilized in conjunction with the processors and/or other processing components to perform any, some, or all of the steps of the processes 200 and 300.

Beginning with FIG. 2, process 200 starts at block 210. At block 220, a wireless microphone unit 110 may detect and receive audio input. In particular, a wireless microphone unit 110 may detect sound in the environment and convert the sound to an analog or digital audio signal via the use of one or more microphone elements of the wireless microphone unit 110. The microphone elements of the wireless microphone unit 110 may be any suitable type of transducer that can detect the sound from an audio source and convert the sound to an electrical audio signal. In an embodiment, the microphone elements may be micro-electrical mechanical system (MEMS) microphones. In other embodiments, the microphone elements may be condenser microphones, balanced armature microphones, electret microphones, dynamic microphones, and/or other types of microphones. In embodiments, the microphone elements may be arrayed in one dimension or two dimensions.

In some embodiments, the microphone elements may be arranged in concentric rings and/or harmonically nested. The microphone elements may be arranged to be generally symmetric, in some embodiments. In other embodiments, the microphone elements may be arranged asymmetrically or in another arrangement. In further embodiments, the microphone elements may be arranged on a substrate, placed in a frame, or individually suspended, for example. In embodiments, the microphone elements may be unidirectional microphones that are primarily sensitive in one direction. In other embodiments, the microphone elements may have other directionalities or polar patterns, such as cardioid, subcardioid, or omnidirectional, as desired.

In some examples, the input audio signal may be stored in a circular buffer of the wireless microphone unit 110, such that a certain time period of audio is constantly stored and updated (e.g., the previous 100 ms, 200 ms, or some other period of time).

At block 230, the wireless microphone unit 110 may perform voice detection and level sensing of the received audio input. This may include classification of the input signal as containing speech or not containing speech. It may also include calculating one or more metrics associated with the input audio signal, such as a signal to noise ratio (SNR), an absolute level (e.g., a power level in decibels), etc. Further, the wireless microphone unit 110 may determine a time stamp corresponding to the input audio signal and/or the determination of the one or more metrics, such that there is a time stamp associated with when the audio signal was received and/or when the metrics were determined.

At this time in the process (e.g., after the audio signal is received), the wireless microphone unit 110 may also take one or more actions to mitigate undesirable noise or audio such as handling noise. As noted above, this may include classifying the input signal as containing voiced speech, unvoiced speech, or non-speech. This classification can then be used as a part of the preliminary gating decision (i.e., in block 240 described below). Furthermore, the classification can be used during a short window of time even after a channel has been granted to a given wireless microphone unit 110, in order to enable the central access point 120 to issue a quick release of the granted channel in the event that the classification is of non-speech, and that classification is received by the central access point 120 after the channel has already been granted. In some embodiments, the wireless microphone units 110 may send a “release channel” control message to the central access point 120 to cause the central access point 120 to release the channel, if and when non-speech classifications are made within the short time window after a channel is granted.

At block 240, the wireless microphone unit 110 may make a preliminary gating decision, which may be an estimate about whether the wireless microphone unit 110 should be granted a communication channel with the central access point 120. To make the preliminary gating decision, the wireless microphone unit 110 may determine whether one or more criteria are met (e.g., whether the input audio includes speech). The wireless microphone unit 110 may also compare the one or more determined metrics of the input audio signal to one or more thresholds. The thresholds may be static thresholds, such as (1) SNR, (2) basic level measurement (BLM), (3) absolute power level, etc. The thresholds may also be dynamic thresholds, which may change based on the particular levels associated with the system, and in particular with other gated on wireless microphone units 110 and/or active communication channels. For instance, these dynamic thresholds may include (1) a MAXBLM threshold, and (2) a MAXBUS threshold. Various other metrics and thresholds may be used as well. The thresholds are described in more detail below.

A BLM value may refer to a measure of a power level of an audio signal. The BLM value may be positive and can be lowpass-filtered so that the effects of high-frequency content are negligible. When converted to decibels, the BLM value may be represented in dBFS, e.g., relative to full-scale, in which case the values may be negative (full-scale is 0 dB).

The MAXBLM threshold may refer to the maximum BLM measurement for all wireless microphone units 110 that are currently gated on. The system can include active signaling loops for each gated on wireless microphone unit 110, which enables the wireless microphone unit 110 to regularly transmit the measured BLM values along with other data to the central access point 120. The central access point 120 may then determine the maximum BLM value from all of the gated on wireless microphone units 110, and the MAXBLM value can be transmitted to the wireless microphone unit 110 and be used as a threshold for the preliminary gating decision.

The MAXBUS value may be similar in some respects to the MAXBLM threshold. In some examples, an advantage may be given to wireless microphone units 110 that are already gated on and have a communication channel granted. This may be called the MAXBUS ADVANTAGE, and it may be a fixed value that is added to the raw BLM value for wireless microphone units 110 which have already been granted a channel. This advantage may enable the system to prioritize channels which are currently active. The MAXBUS value may be determined by the central access point 120 as the maximum BLM value for all gated on wireless microphone unit 110 added to the MAXBUS ADVANTAGE value.

Other metrics may be used as well in the preliminary gating decision. For example, there may be an inactive MAXBLM threshold, which can be determined to be the maximum BLM for wireless microphone units 110 which have not been granted a channel or are not gated on. Wireless microphone units 110 that are not gated on may have an inactive signaling loop with the central access point 120, in which the wireless microphone units 110 periodically transmit information (e.g., BLM) to the central access point 120 via control packets, since they do not have an active communication channel for audio data.

In some examples, the system may include automatic gain control functionality, and/or feedback reduction (also known as dynamic feedback reduction). Regarding automatic gain control, the wireless microphone unit 110 may adjust the level of an input audio signal to achieve a consistent desired target power level. The wireless microphone unit 110 may automatically adapt the gain and/or attenuation level corresponding to the input audio signal, based on characteristics or metrics of the input audio signal while desirable sound is detected (e.g., speech). This automatic gain control may result in a more balanced mix output by the central access point 120, such as by normalizing levels across all input audio signals. This may assist in compensating for input level differences due to loud or soft talkers, people who speak near or far from a wireless microphone unit 110, an audio source being on or off axis from a wireless microphone unit 110 if the unit includes directional microphones, and/or for various other reasons.

One or more wireless microphone units 110 may also include circuitry and functionality related to feedback reduction or dynamic feedback reduction. The wireless microphone unit 110 may detect the presence of audio feedback in the input audio signal, and responsively deploy one or more filters based on the characteristics or metrics of the feedback, in order to reduce or eliminate the feedback effect. Dynamic feedback reduction may be performed by the wireless microphone unit 110 on an input audio signal, in particular where the wireless microphone unit 110 has been granted a communication channel and is in the process of transmitting the input audio to the central access point 120. In an exemplary scenario, the input audio signal is being transmitted to the central access point 120 (where the input audio signal is included in the final output mix), and the output mix is picked up by the wireless microphone unit 110. The wireless microphone unit 110 may pick up the output mix which includes the input audio signal, which may cause the feedback to occur. This feedback can then by mitigated by deploying one or more filters as appropriate.

With respect to the preliminary gating decision (e.g., when the wireless microphone unit 110 has not yet been granted an active communication channel), there may not be the typical feedback as noted in the scenario mentioned above (e.g. the wireless microphone unit 110 picking up the final output mix which includes the input audio from the wireless microphone unit 110). However, the dynamic feedback reduction functionality may be used in a different manner to assist with the preliminary gating decision. In particular, when multiple wireless microphone units 110 are present, a first wireless microphone unit 110 may cause a feedback signal to occur, e.g., through the typical process of transmitting its corresponding input audio signal and picking up the output mix that includes the input audio signal. This undesirable feedback signal may then be picked up by one or more other wireless microphone units 110, such as a unit that is adjacent or nearby the first wireless microphone unit 110. The second wireless microphone unit 110 may interpret the feedback signal as a desirable input audio signal, which may result in a positive preliminary gating decision by the second wireless microphone unit 110. However, since this feedback signal is undesirable, instead of making a positive preliminary gating decision, the second wireless microphone unit 110 may instead use its dynamic feedback reduction capabilities to address the feedback signal, and determine that it is not a desirable input audio signal. The second wireless microphone unit 110 can then make a negative preliminary gating decision based on its recognition that the input audio signal is simply a feedback signal, and is not a desirable input audio signal. In this manner, a wireless microphone unit 110 may use dynamic feedback reduction as a mechanism for preventing positive preliminary gating decisions (and thus preventing access requests from being sent) when the input audio signal includes feedback or has feedback characteristics.

If a wireless microphone unit 110 determines that the input audio signal meets one or more criteria and/or is above one or more thresholds, then the wireless microphone unit 110 may make a preliminary gating decision of YES at block 240. However, if the wireless microphone unit 110 determines that the input audio signal does not meet one or more criteria and/or is not above one or more thresholds at block 240, then the wireless microphone unit 110 may make a preliminary gating decision of NO. The process 200 may proceed back to block 220 where the wireless microphone unit 110 may receive a new input audio signal.

It should be appreciated that while the embodiment illustrated above describes that wireless microphone unit 110 may make a preliminary gating decision of YES at block 240 based on whether the input audio signal meets one or more criteria and/or is above one or more thresholds, in other embodiments, the wireless microphone unit 110 may make a preliminary gating decision of NO at block 240 based on whether the input audio signal does not meet one or more criteria and/or is below one or more thresholds.

If the wireless microphone unit 110 makes a positive preliminary gating decision (“YES”) at block 240, at block 250 the wireless microphone unit 110 may transmit an access request to the central access point 120. The access request may include a request for a wireless communications channel to be granted to the wireless microphone unit 110, and/or include various metrics and data concerning the input audio signal (e.g., BLM, SNR, timestamp, etc.). While the term “access request” may be used herein, other terms may be used as well such as “speak request” or “enhanced speak request.” A purpose of the access request is to enable the wireless microphone unit 110 to request that the central access point 120 grant a communication channel for the purpose of transmitting the input audio signal from the wireless microphone unit 110 to the central access point 120. As such, while many of the access requests may pertain to requests from the wireless microphone unit 110 to transmit speech, it should be understood that the access request may pertain to other requests for access, such as, but not limited to, a music request, a data transmission request, and/or any other reason for which the wireless microphone unit 110 would want a channel granted.

In some examples where the wireless microphone unit 110 is configured to make a determination whether the input audio signal comprises speech or non-speech, there may be a delay in making this determination. In some cases, the delay may be variable and/or unknown due to the processing time required to make the determination, and/or due to the determination being based on the generation of a confidence level (e.g., when obtaining a higher quality confidence level based on a longer input audio signal and/or longer processing time). In these cases, the wireless microphone unit may make an initial determination that the input audio signal should be transmitted to the central access point 120, and may subsequently be granted a channel. However, if the wireless microphone unit 110 performs additional processing and later determines that the input audio signal does not include speech (and therefore should not be granted a channel), the wireless microphone unit 110 may transmit a release channel control message to the central access point 120 in order to release the channel.

The above scenario describes the case where a wireless microphone unit 110 makes an initial decision to transmit an access request (e.g., an enhanced speak request) and later determines that the request was made in error, and therefore transmits a release channel control message. The wireless microphone unit 110 may perform similar steps where the input audio signal is relatively short in duration, e.g., where the input audio signal has stopped by the time the channel is granted and set up for communication. In this case, the wireless microphone unit 110 may also transmit a release channel control message to release the channel. An example of an audio signal that is relatively short in duration includes when a book or other object is dropped and the sound is picked up by the wireless microphone unit 110, or when the wireless microphone unit 110 is being handled to be moved.

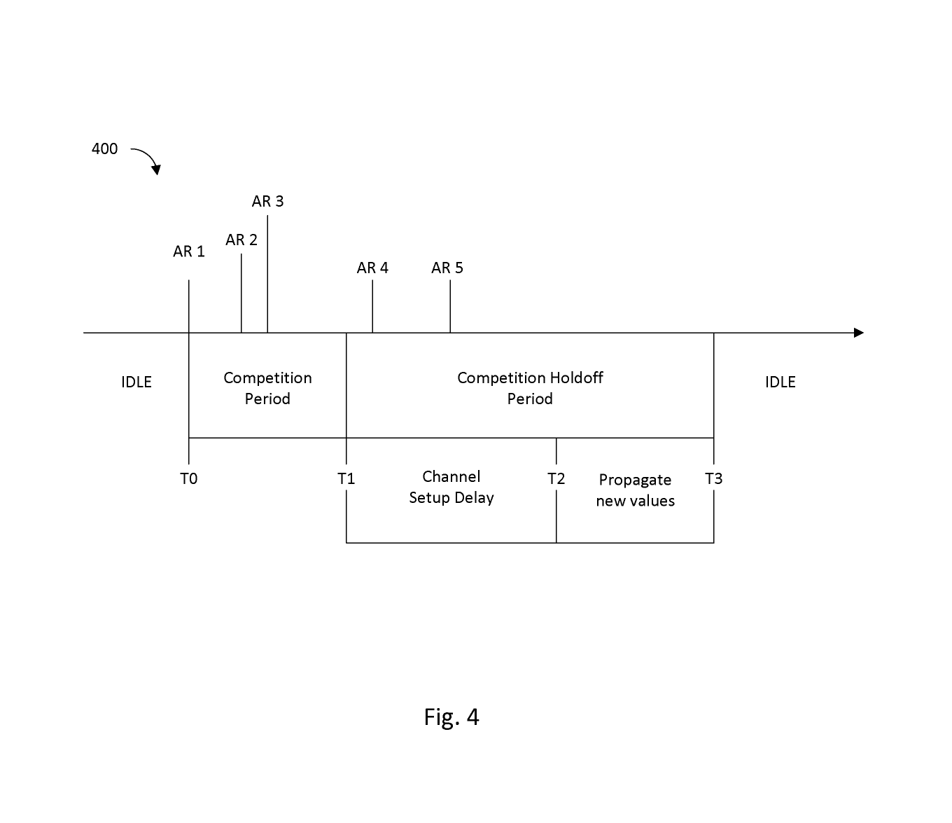

Referring now to FIG. 3, process 300 begins at block 310. At block 320, the central access point 120 may receive a first access request from a wireless microphone unit 110. Receiving the first access request may begin a series of events, which are described in further detail below with respect to the timing diagram shown in FIG. 4.

At block 330, in response to receiving a first access request from a first wireless microphone unit 110, the central access point 120 may begin a competition period. During the competition period, it may be expected that additional access requests may be received from additional wireless microphone units 110 which may have picked up the same audio source as the first wireless microphone unit 110 (albeit possibly delayed slightly due to being different distances from the audio source). The central access point 120 may store the first access request and/or the corresponding signal metrics in a buffer. During the competition period, if additional access requests are received from other wireless microphone units 110, the signal metrics may be extracted and compared to the previously received data. The best signal metrics (and the corresponding wireless microphone unit 110) may be updated until the end of the competition period, at which time the “winning” wireless microphone unit 110 may be determined.

At block 340, the central access point 120 may make a final gating decision, which includes selecting the winning wireless microphone unit 110. The winning wireless microphone unit 110 may be the wireless microphone unit 110 having an audio signal that has the highest SNR, highest absolute level, best level of some other metric, earliest corresponding time stamp, and/or for some other reason. In some cases where the system operates using data packets, some requests and/or packets may be lost or delayed during transmission to the central access point 120. However, it may be desirable to select the wireless microphone unit 110 that is closest to a talker (e.g., the wireless microphone unit 110 that picked up the speech first), and which may include the second or subsequent access request if, for example, such a request has an earlier timestamp corresponding to when the input audio was received at the second or subsequent wireless microphone unit 110. This may occur even though the second or subsequent access request was received by the central access point 120 after the first access request of the first wireless microphone unit 110. In some examples, selecting the winning wireless microphone unit 110 may be performed by examining time stamps down to the subframe level (e.g., with a resolution of approximately 1 ms).

In some examples, the central access point 120 may factor in noise when making a decision about which wireless microphone unit 110 is the winner. For example, a higher noise level from a particular wireless microphone unit 110 may indicate that this wireless microphone unit 110 is closer to the source of the noise, since noise typically attenuates based on distance.

Additionally, in further examples, the central access point 120 may factor in system channel capacity when determining which wireless microphone unit 110 is the winner, and/or whether to select a winning wireless microphone unit 110 at all. For instance, if the maximum number of channels are already being utilized in the system, no wireless microphone unit 110 may be selected as the winner.

When a winning wireless microphone unit 110 is selected during the final gating decision process of block 340, the central access point 120 may grant a communication channel for audio data to the winning wireless microphone unit 110. The central access point 120 may generate a final output mix audio signal at block 350. The final output mix audio signal may reflect the desired audio mix of signals from the wireless microphone units 110, and/or one or more other audio sources which may be connected to the central access point 120 either wirelessly or via wired connections. In embodiments, the final output mix audio signal may be transmitted to a remote location (e.g., far end of a conference) and/or be played in the environment for sound reinforcement, for example.

In some examples, the central access point 120 may differentiate between (1) access requests received from wireless microphone units 110 with the capability and functions described herein, and (2) ordinary channel requests received from wireless microphone units or devices without the functionality described herein. The ordinary channel requests may be processed independently or separately from the process described herein.

FIG. 4 illustrates a timing diagram showing the timing of various stages of the central access point 120 during the process of selecting a winning wireless microphone unit 110. In FIG. 4, prior to time T0, several wireless microphone units 110 may receive input audio from an audio source. Each wireless microphone unit 110 may make a preliminary gating decision, and several of the wireless microphone units 110 may transmit access requests (AR) to the central access point 120.

At time T0, the first AR may be received by the central access point 120. Prior to time T0, the central access point 120 may be in an idle state where it may be able to receive ARs and is operating under normal circumstances (e.g., generating a final mixed audio output).

When the first AR is received, the central access point 120 may begin a competition period. During the competition period, the central access point 120 may be able to receive subsequent ARs from various other wireless microphone units 110. As shown in FIG. 4, the central access point 120 may receive two additional ARs during the competition period, e.g., AR 2 and AR 3. The central access point 120 may compare the metrics included in the received ARs against each other to determine which AR (and thus the corresponding wireless microphone unit 110) is the winner.

A length of the competition period may be determined based on several factors. In particular, the competition period length may be determined based on the spacing of the wireless microphone units 110 and the speed of sound. The wireless microphone units 110 may be spaced apart from each other by a known distance, and based on this known distance along with the speed of sound, it can be predicted how long of a delay there will likely be between ARs received from two adjacent wireless microphone units 110 (e.g., when both wireless microphone units 110 pick up the same audio source). Additionally, the competition period duration may be determined such that it is short enough that only a limited number of wireless microphone units 110 will be able to transmit ARs based on the same audio source (e.g., when a person begins speaking and two or more wireless microphone units 110 all pick up the speech). Based on how far sound can travel in a given amount of time, utilizing a relatively short competition period length may ensure that only wireless microphone units 110 within a given distance of the first wireless microphone unit 110 to send an AR have the opportunity to send a competing AR.

At time T1, the competition period may end, and the winning AR (and therefore the winning wireless microphone unit 110) may be selected. Also at time T1, a competition holdoff period may begin. All ARs received during the competition holdoff period may be blocked or ignored by the central access point 120 (e.g., AR 4 and AR 5 shown in FIG. 4). In practice, AR 1, AR 2, AR 3, AR 4, and AR 5 may correspond to the closest wireless microphone units 110, in order of distance, to an audio source. In this scenario, it may be desirable to block requests from the fourth and fifth closest wireless microphone units 110 given that there are three closer candidates to choose from. In some examples, ARs received during the competition holdoff period may be ignored, and the wireless microphone units 110 making these requests may time out and transmit a new request later and/or retransmit the request, which can result in starting a new competition period, e.g., after time T3 when requests can be received and processed again.

Between time T1 and time T2, the winning wireless microphone unit may be granted a wireless communication channel, and the channel setup procedure may be carried out. The winning wireless microphone unit 110 may also begin to transmit audio via the granted communication channel.

Between time T2 and time T3, the central access point 120 may transmit new metrics (e.g., MAXBUS, MAXBLM, etc.) to the wireless microphone units 110 for use in making their preliminary gating decisions. The updated metrics may be useful to the wireless microphone units 110 at this stage, since the winning wireless microphone unit 110 has just been granted a communication channel and there may be new metrics for the other wireless microphone units 110 to use in their decision making.

At the end of the competition holdoff period (time T3), new ARs can again be received. The next received AR after time T3 may begin a new competition period for the next available channel. However, the previous winning wireless microphone unit 110 may remain active on the previously granted channel.

The length of the competition holdoff period may be determined based on various factors, including: (1) the amount of time required to grant a channel to the winning wireless microphone unit 110 (e.g., longer required time to grant means a longer competition holdoff period), (2) based on a need to allow time for the winning wireless microphone unit 110 to begin transmitting audio on the granted channel, and/or (3) based on the time required to update and transmit the updated metrics to the other wireless microphone units 110 (e.g., MAXBUS, MAXBLM, or other relevant metrics). Delaying the start of the next competition period may ensure that the next competition period reflects requests from wireless microphone units 110 that have already incorporated the new metrics into their preliminary gating decisions.

In general, a computer program product in accordance with the embodiments includes a computer usable storage medium (e.g., standard random access memory (RAM), an optical disc, a universal serial bus (USB) drive, or the like) having computer-readable program code embodied therein, wherein the computer-readable program code is adapted to be executed by a processor (e.g., working in connection with an operating system) to implement the methods described below. In this regard, the program code may be implemented in any desired language, and may be implemented as machine code, assembly code, byte code, interpretable source code or the like (e.g., via C, C++, Java, ActionScript, Objective-C, JavaScript, CSS, XML, and/or others).

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The terms “includes,” “including,” and “include” are inclusive and have the same scope as “comprises,” “comprising,” and “comprise” respectively.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

This disclosure is intended to explain how to fashion and use various embodiments in accordance with the technology rather than to limit the true, intended, and fair scope and spirit thereof. The foregoing description is not intended to be exhaustive or to be limited to the precise forms disclosed. Modifications or variations are possible in light of the above teachings. The embodiment(s) were chosen and described to provide the best illustration of the principle of the described technology and its practical application, and to enable one of ordinary skill in the art to utilize the technology in various embodiments and with various modifications as are suited to the particular use contemplated. All such modifications and variations are within the scope of the embodiments as determined by the appended claims, as may be amended during the pendency of this application for patent, and all equivalents thereof, when interpreted in accordance with the breadth to which they are fairly, legally and equitably entitled.

1-20. (canceled)

21. A wireless audio system, comprising:a plurality of wireless microphone units each configured to:determine a preliminary gating decision based on at least an audio input signal;and wirelessly transmit an access request based on the preliminary gating decision,wherein the access request is for requesting a grant of a wireless communication channel;and a central access point in wireless communication with the plurality of wireless microphone units, the central access point configured to grant the wireless communication channel for a selected designated wireless microphone unit of the plurality of wireless microphone units, at least partially based on at least one access request received from at least one of the plurality of wireless microphone units.

22. The wireless audio system of claim 21, wherein the plurality of wireless microphone units are each further configured to determine the preliminary gating decision based on information received from the central access point.

23. The wireless audio system of claim 21, wherein the plurality of wireless microphone units are each further configured to determine the preliminary gating decision at least partially based on a metric associated with the audio input signal.

24. The wireless audio system of claim 21, wherein the plurality of wireless microphone units are each further configured to:perform dynamic feedback reduction on the audio input signal; anddetermine the preliminary gating decision at least partially based on the dynamic feedback reduction performed on the audio input signal.

25. The wireless audio system of claim 21, wherein the central access point is further configured to, responsive to receiving the at least one access request, select the designated wireless microphone unit based on the at least one access request.

26. The wireless audio system of claim 21, wherein the central access point is further configured to, responsive to receiving the at least one access request:initiate a competition period;receive subsequent access requests during the competition period from other wireless microphone units of the plurality of wireless microphone units; andselect the designated wireless microphone unit based on the at least one access request and the subsequent access requests.

27. The wireless audio system of claim 21, wherein the plurality of wireless microphone units are each further configured to:
determine whether to classify the audio input signal as non-speech during a predetermined time duration after the wireless communication channel has been granted;and wirelessly transmit a channel release request to the central access point, when the audio input signal is classified as non-speech; andwherein the central access point is further configured to release the granted wireless communication channel, responsive to the channel release request.

28. The wireless audio system of claim 21, wherein the plurality of wireless microphone units are each further configured to responsive to the grant of the wireless communication channel, initiate playback of a time-compressed audio signal that is generated based on the audio input signal.

29. A wireless microphone unit configured to:detect an audio input signal;determine, based on at least the audio input signal, a preliminary gating decision; andresponsive to the preliminary gating decision being a positive gating decision, wirelessly transmit an access request to a central access point, the access request for requesting a grant of a wireless communication channel between the wireless microphone unit and the central access point.

30. The wireless microphone unit of claim 29, wherein the wireless microphone unit is further configured to determine the preliminary gating decision based on information received from the central access point.

31. The wireless microphone unit of claim 29, wherein the wireless microphone unit is further configured to determine the preliminary gating decision at least partially based on a metric associated with the audio input signal.

32. The wireless microphone unit of claim 29, wherein the wireless microphone unit is further configured to:perform dynamic feedback reduction on the audio input signal; anddetermine the preliminary gating decision at least partially based on the dynamic feedback reduction performed on the audio input signal.

33. The wireless microphone unit of claim 29, wherein the wireless microphone unit is further configured to:determine whether to classify the audio input signal as non-speech during a predetermined time duration after the wireless communication channel has been granted; andwirelessly transmit a channel release request to the central access point, when the audio input signal is classified as non-speech, wherein the channel release request is for requesting a release of the granted wireless communication channel.

34. The wireless microphone unit of claim 29, wherein the wireless microphone unit is further configured to responsive to the grant of the wireless communication channel, initiate playback of a time-compressed audio signal that is generated based on the audio input signal.

35. A central access point configured to:wirelessly receive at least one access request from at least one of a plurality of wireless microphone units, wherein the at least one access request is for requesting a grant of a wireless communication channel between the at least one of the plurality of wireless microphone units and the central access point, and wherein the at least one access request is wirelessly transmitted from the at least one of the plurality of wireless microphone units based on a preliminary gating decision determined based on at least an audio input signal detected by the at least one of the plurality of wireless microphone units; andgrant the wireless communication channel for a selected designated wireless microphone unit of the plurality of wireless microphone units at least partially based on the at least one access request received from the at least one of the plurality of wireless microphone units.

36. The central access point of claim 35, wherein the central access point is further configured to transmit information to the at least one of the plurality of wireless microphone units, and wherein the preliminary gating decision is determined by the at least one of the plurality of wireless microphone units based on the information transmitted from the central access point.

37. The central access point of claim 35, wherein the preliminary gating decision is determined by the at least one of the plurality of wireless microphone units at least partially based on a metric associated with the audio input signal.

38. The central access point of claim 35, wherein the central access point is further configured to, responsive to wirelessly receiving the at least one access request, select the designated wireless microphone unit based on the at least one access request.

39. The central access point of claim 35, wherein the central access point is further configured to, responsive to receiving the at least one access request:initiate a competition period;wirelessly receive subsequent access requests during the competition period from other wireless microphone units of the plurality of wireless microphone units; andselect the designated wireless microphone unit based on the at least one access request and the subsequent access requests.

40. The central access point of claim 39, wherein the central access point is further configured to select the designated wireless microphone unit by:selecting the at least one access request as a designated access request;processing each of the subsequent access requests in the order received;updating the designated access request based on the processing of the subsequent access requests; and
at the end of the competition period, select the designated wireless microphone unit based on the updated designated access request.
